(19) United States
(12) Patent Application Publication
(10) Pub. No.: US 2006/0266286 A1
(43) Pub. Date: Nov. 30, 2006

(54) DROPLET DISCHARGE DEVICE, METHOD OF MANUFACTURING LIQUID CRYSTAL DISPLAY AND LIQUID CRYSTAL DISPLAY

(75) Inventor: Osamu KASUGA, Suwa (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 11/420,865

(22) Filed: May 30, 2006

(30) Foreign Application Priority Data
May 31, 2005 (JP) 2005-158521

(51) Int. Cl. B05C 11/00; B05C 5/00

(52) U.S. Cl. 118/666; 118/300; 118/305

(57) ABSTRACT

A droplet discharge device includes a droplet discharger that moves above and relative to a plurality of discharge-target regions formed on a substrate and discharges a droplet of a liquid substance on the discharge-target region, a liquid substance heater that heats the liquid substance in the droplet discharger, and a substrate temperature controller that sets the absolute value of an amount of heat transferred to a vicinity of an outer periphery of the substrate larger than the absolute value of an amount of heat transferred to a vicinity of a center position of the substrate.

### BACKGROUND

1. Technical Field

The present invention relates to a droplet discharge device, a method of manufacturing a liquid crystal display, and a liquid crystal display.

2. Related Art

As one of manufacturing steps for a liquid crystal display, a sealing step is carried out, in which a liquid crystal as a liquid substance is discharged on discharge-target regions on a transparent substrate and then the discharge-target regions are sealed by a counter substrate. This sealing step involves a problem in that, when there is variation in the volume of the liquid crystal discharged on the discharge-target regions, the distance (cell gap) between the transparent substrate and the counter substrate varies, which deteriorates the quality of images displayed on the liquid crystal display. Therefore, as a method for suppressing the variation in the volume of the discharged liquid crystal, a so-celled ink jet method in which the liquid crystal is discharged as small droplets has been proposed in JP-A-5-281562, for example.

Typically in this ink jet method, the boundary (meniscus) of a liquid substance in a discharge nozzle is forcibly vibrated due to the expansion and contraction of a piezoelectric element or the like. Through this vibration process, the liquid substance having the meniscus is discharged as the droplets. However, a liquid crystal with a high viscosity in the range from e.g. 50 cp to 100 cp involves a problem in that it is difficult to discharge the liquid crystal having the meniscus by use of the vibration, which varies the volume of the droplets or precludes the formation of the droplets.

In order to address this problem, a method that allows a liquid substance having a high viscosity to be discharged as droplets with a uniform volume has been proposed in JP-A-2004-358352, for example. In the method of this JP-A-2004-358352, a droplet discharge head having discharge nozzles and a feed line for supplying a liquid crystal to the droplet discharge head are heated with use of a heating unit such as a tube heater, and thereby the viscosity of the liquid crystal in the vicinity of its meniscus is decreased. Thus, a liquid substance (liquid crystal) with a high viscosity can be discharged as droplets having a uniform volume.

However, in the above-described ink jet method, openings of the discharge nozzles (nozzle plate of the droplet discharge head) are brought close to discharge-target regions on the transparent substrate in order to ensure the accuracy of the landing positions of discharged droplets. Therefore, the temperature of the liquid crystal in the discharge nozzles varies due to a heat exchange with the transparent substrate in addition to a heat exchange with the ambient air.

As a result, the temperature of the liquid crystal in the discharge nozzles, i.e., the viscosity of the liquid crystal varies depending on the temperature distribution on the transparent substrate and the period during which the droplet discharge head stays above the transparent substrate (the period of a head exchange), which problematically varies the volume of the liquid crystal discharged on the discharge-target regions.

### SUMMARY

An advantage of some aspects of the invention is to provide a droplet discharge device that discharges as droplets a liquid substance having a high viscosity on a plurality of discharge-target regions formed on a substrate, with allowing a high uniformity of the volume of the liquid substance discharged on the respective discharge-target regions. In addition, another advantage of some aspects of the invention is to provide a method of manufacturing a liquid crystal display and a liquid crystal display.

A droplet discharge device according to a first aspect of the invention includes a droplet discharger that moves above and relative to a plurality of discharge-target regions formed on a substrate and discharges a droplet of a liquid substance on the discharge-target region, a liquid substance heater that heats the liquid substance in the droplet discharger, and a substrate temperature controller that sets the absolute value of an amount of heat transferred to a vicinity of an outer periphery of the substrate larger than the absolute value of an amount of heat transferred to a vicinity of a center position of the substrate.

The droplet discharge device of the first aspect can transfer to the vicinity of the outer periphery, which readily exchanges heat with an ambient air, heat of which amount has an absolute value larger than the absolute value of the amount of heat transferred to the vicinity of the center position. Therefore, when the temperature of the ambient air is lower than that of the substrate, the lowering of the temperature of the vicinity of the outer periphery relative to the temperature of the vicinity of the center position can be suppressed. In contrast, when the temperature of the ambient air is higher than that of the substrate, an increase of the temperature of the vicinity of the outer periphery relative to the temperature of the vicinity of the center position can be suppressed. As a result, it is possible to suppress variation in the amount of heat transferred from the substrate during the relative movement of the droplet discharger above the respective discharge-target regions. Accordingly, the uniformity of the viscosity of the liquid substance to be discharged on the discharge-target regions can be enhanced, and thus the uniformity of the volume of the liquid substance discharged on the discharge-target regions can be enhanced.

In the droplet discharge device, the substrate temperature controller may heat the substrate so as to set the temperature of the vicinity of the outer periphery of the substrate higher than the temperature of the vicinity of the center position of the substrate.

According to this droplet discharge device, when the droplet discharger is positioned in the vicinity of the center position of the substrate, a small positive heat can be supplied from a wide area on the substrate to the droplet discharger. On the contrary, when the droplet discharger is positioned in the vicinity of the outer periphery of the substrate, a large positive heat can be supplied from a small area on the substrate to the droplet discharger. That is, it is possible to suppress variation in the amount of positive heat transferred from the substrate to the droplet discharger during the relative movement of the droplet discharger above the respective discharge-target regions. In addition, heating the substrate can reduce a heat exchange between the droplet discharger and the substrate.

Therefore, since a temperature gradient is made between the vicinity of the center position and the vicinity of the outer periphery of the substrate, it is possible to suppress variation in the viscosity of the liquid substance in the droplet discharger when the droplet discharger is positioned above the discharge-target regions. As a result, the uniformity of the volume of the liquid substance discharged on the discharge-target regions can be enhanced more surely.

In the droplet discharge device, the substrate temperature controller may provide the substrate with a temperature gradient along a relative movement direction of the droplet discharger in advance so that heat transferred from the droplet discharger to the substrate is cancelled at the discharge-target region facing the droplet discharger.

According to this droplet discharge device, when heat from the heater and droplet discharger are accumulated in the substrate, an increase of the temperature of the discharge-target regions facing the droplet discharger can be canceled by use of a temperature gradient along the relative movement direction of the droplet discharger. Therefore, variation in the amount of heat transferred from the substrate to the droplet discharger can be suppressed irrespective of the heater, the relative movement path of the droplet discharger above the substrate, and the stay period of the droplet discharger above the substrate. As a result, the liquid substance with a more uniform volume can be discharged on all the discharge-target regions formed on the substrate.

A droplet discharge device according to a second aspect of the invention includes a droplet discharger that moves above and relative to a plurality of discharge-target regions formed on a substrate and discharges a droplet of a liquid substance on the discharge-target region, a liquid substance heater that heats the liquid substance in the droplet discharger, and a substrate temperature controller that provides the substrate with a temperature gradient along a relative movement direction of the droplet discharger in advance so that heat transferred from the droplet discharger is cancelled.

According to the droplet discharge device of the second aspect, when heat from the heater and droplet discharger are accumulated in the substrate, an increase of the temperature of the discharge-target regions facing the droplet discharger can be canceled by use of a temperature gradient along the relative movement direction of the droplet discharger. Therefore, variation in the amount of heat transferred from the substrate to the droplet discharger can be suppressed irrespective of the heater, the relative movement path of the droplet discharger above the substrate, and the movement period of the droplet discharger above the substrate. As a result, the liquid substance with a more uniform volume can be discharged on all the discharge-target regions formed on the substrate.

In the droplet discharge device, the substrate temperature controller may include a heater for heating the substrate.

According to this droplet discharge device, the uniformity of the volume of the liquid substance discharged on the discharge-target regions can be enhanced due to the distribution of the amount of heat from the heater.

In the droplet discharge device, the substrate temperature controller may include a substrate stage on which the substrate is placed so that the substrate is allowed to move relative to the droplet discharger.

According to this droplet discharge device, temperature control can be carried out for a moving substrate (discharge-target regions) more smoothly. As a result, the uniformity of the volume of the liquid substance discharged on the discharge-target regions can be enhanced without the processing performance of the droplet discharge processing being deteriorated.

In the droplet discharge device, the liquid substance may be a liquid crystal.

According to this droplet discharge device, the uniformity of the volume of a liquid crystal discharged on the discharge-target regions can be enhanced.

A method of manufacturing a liquid crystal display according to a third aspect of the invention includes discharging a liquid crystal on either one of an element substrate and a counter substrate with use of the above-described droplet discharge device, and sealing the discharged liquid crystal in a gap between the element substrate and the counter substrate.

The method of manufacturing a liquid crystal display of the third aspect allows the manufacturing of a liquid crystal display in which the uniformity of the volume of a sealed liquid crystal is enhanced.

A liquid crystal display according to a fourth aspect of the invention is manufactured by the above-described method of manufacturing a liquid crystal display.

According to the liquid crystal display of the fourth aspect, the uniformity of the volume of a sealed liquid crystal can be enhanced.

### BRIEF DESCRIPTION OF THE DRAWINGS

The invention will be described with reference to the accompanying drawings, wherein like numbers reference like elements.

FIG. 1 is a schematic perspective view of a liquid crystal display of an embodiment of the invention.

FIG. 2 is a schematic sectional view of the liquid crystal display of the embodiment.

FIG. 3 is a schematic perspective view for explaining a method of manufacturing the liquid crystal displays of the embodiment.

FIG. 4 is a plan view for explaining the method of manufacturing the liquid crystal displays of the embodiment.

FIG. 5 is a schematic perspective view of a droplet discharge device of the embodiment.

FIG. 6 is a schematic sectional view of the droplet discharge device of the embodiment.

FIG. 7 is a plan view for explaining substrate heaters of a first embodiment of the invention.

FIG. 8 is a schematic perspective view for explaining a droplet discharge head of the first embodiment.

FIG. 9 is a sectional view for explaining major parts of the droplet discharge head of the first embodiment.

FIG. 10 is a schematic sectional view for explaining the droplet discharge head and a discharge-target substrate of the first embodiment.

FIG. 11 is an electric block circuit diagram for explaining the electric configuration of the droplet discharge device of the first embodiment.

FIG. 12 is a plan view for explaining substrate heaters of a second embodiment of the invention.

FIG. 13 is an explanatory diagram for explaining the relative movement path of a droplet discharge head of the second embodiment.

### DESCRIPTION OF EXEMPLARY EMBODIMENTS

### First Embodiment

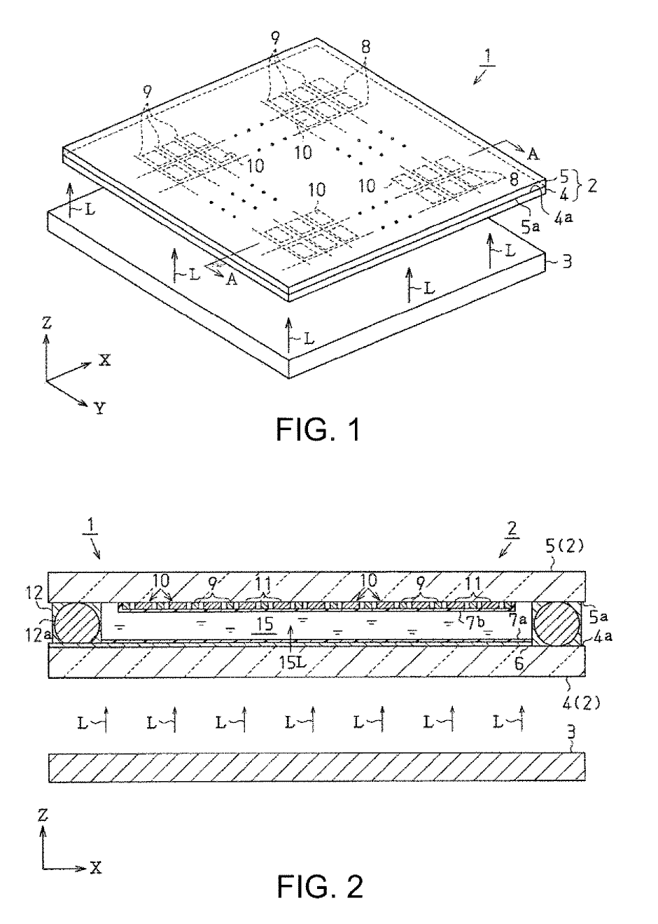

A first embodiment of the invention will be described below with reference to FIGS. 1 to 11. Initially, a description will be made on a liquid crystal display according to one embodiment of the invention. FIG. 1 is a perspective view of the liquid crystal display. FIG. 2 is a sectional view along line A-A in FIG. 1.

Referring to FIG. 1, a liquid crystal display 1 includes a liquid crystal panel 2 and a planar illumination unit 3 that illuminates the liquid crystal panel 2 with planar light (flat light L). The liquid crystal panel 2 has a counter substrate 4 facing the emitting plane of the flat light L, and an element substrate 5 opposed to the counter substrate 4.

The counter substrate 4 is a non-alkali glass substrate formed into a rectangular plate shape. On the plane (upper plane) thereof facing the element substrate 5 (counter electrode formed plane 4a), a counter electrode 6 that is formed of a transparent conductive layer made of an indium tin oxide (ITO) or the like is deposited, so as to be supplied with a predetermined common potential from a power supply circuit (not shown). Deposited on the counter electrode 6 is an alignment layer 7a for which alignment treatment employing rubbing treatment and so forth has been carried out, so that the orientation of a liquid crystal 15 that will be described later is set to a predetermined orientation in the vicinity of the counter electrode 6.

As shown in FIG. 1, the element substrate 5 is a non-alkali glass substrate formed into a rectangular plate shape substantially similarly to the counter substrate 4. On the plane (lower plane) thereof facing the counter substrate 4 (element formed plane 5a), a plurality of scan lines 8 that extend in the X-axis direction are formed with a predetermined interval. Each of the scan lines 8 is electrically coupled to a scan line drive circuit (not shown). The scan line 8 is selectively driven at certain timing, and a corresponding scan signal is output at certain timing. In addition, formed on the element formed plane 5a are a plurality of data lines 9 that extend in the Y-axis direction perpendicularly intersecting with the scan lines 8 with a predetermined interval. Each of the data lines 9 is electrically coupled to a data line drive circuit (not shown), so that a data signal based on display data is input to the corresponding data line 9 at certain timing.

On the intersections between the scan lines 8 and the data lines 9, a plurality of pixel regions 10 arranged in a matrix are formed. Each of the pixel regions 10 is coupled to the corresponding scan line 8 and the corresponding data line 9. Formed in each of the pixel regions 10 are a control element formed of a thin film transistor (TFT) or the like (not shown), and a pixel electrode 11 (see FIG. 2) formed of a transparent conductive film such as an ITO film.

As shown in FIG. 2, on the lower surface of the data lines 9 (scan lines 8) and the pixel electrodes 11 (the surface facing the counter substrate 4), an alignment layer 7b for which alignment treatment employing rubbing treatment and so forth has been carried out is deposited, so that the orientation of the liquid crystal 15 that will be described later is set to a certain orientation in the vicinity of the pixel electrodes.

In the gap between the element substrate 5 (alignment layer 7b) and the counter substrate 4 (alignment layer 7a), a sealing member 12 that includes electrically conductive particles 12a having a substantially spherical shape and is formed into a rectangular frame shape are provided.

The sealing member 12 is formed by discharging UV-setting resin or the like in which the conductive particles 12a are dispersed into a rectangular frame shape along the outer periphery of the counter substrate 4 by use of a dispenser, screen printing or another method, and then irradiating the discharged UV-setting resin or the like with ultra-violet rays or the like so as to cure the UV-setting resin or the like. The provision of the sealing member (conductive particles 12a) on the outer periphery of each of the counter substrate 4 and the element substrate 5 offers the separation between the outer periphery of the element substrate 5 (element formed plane 5a) and the outer periphery of the counter substrate 4 (counter electrode formed plane 4a) by a predetermined distance substantially equal to the outer diameter of the conductive particles 12a.

In addition, in the above-described gap between the element substrate 5 (alignment layer 7b) and the counter substrate 4 (alignment layer 7a), a liquid crystal layer 15L composed of the liquid crystal 15 as a liquid substance to be sealed by the sealing member 12 is formed.

When the scan lines 8 are sequentially selected one by one based on line-sequential scanning, the control elements in the pixel regions 10 sequentially enters the on-state only during the period when the corresponding scan line 8 is selected. Thus, a data signal is output to the corresponding pixel electrode 11 via the corresponding data line 9 and the corresponding control element. Then, according to the potential difference between the pixel electrode 11 on the element substrate 5 and the counter electrode 6, the alignment state of the liquid crystal 15 is maintained so that the flat light L is modulated. Thus, a desired image is displayed on the liquid crystal panel 2 depending on whether or not the modulated light passes through a polarizing plate (not shown).

In the above-described liquid crystal panel 2, the volume of the liquid crystal 15 is equalized across the entire liquid crystal panel 2, which allows the uniformity of the gap (cell gap) between the element substrate 5 (alignment layer 7b) and the counter substrate 4 (alignment layer 7a). Thus, the quality of displayed images on the liquid crystal panel 2 can be maintained. Although the liquid crystal display 1 of the present embodiment is a so-called active-matrix liquid crystal display that includes TFTs as control elements in the pixel regions 10, the liquid crystal display 1 may be e.g. a passive-matrix liquid crystal display. In addition, the liquid crystal display 1 of the present embodiment has a configuration in which the counter substrate 4 faces the emitting plane of the flat light L. However, the invention is not limited to this configuration, but may have a configuration in which the element substrate 5 faces the emitting plane of the flat light L.

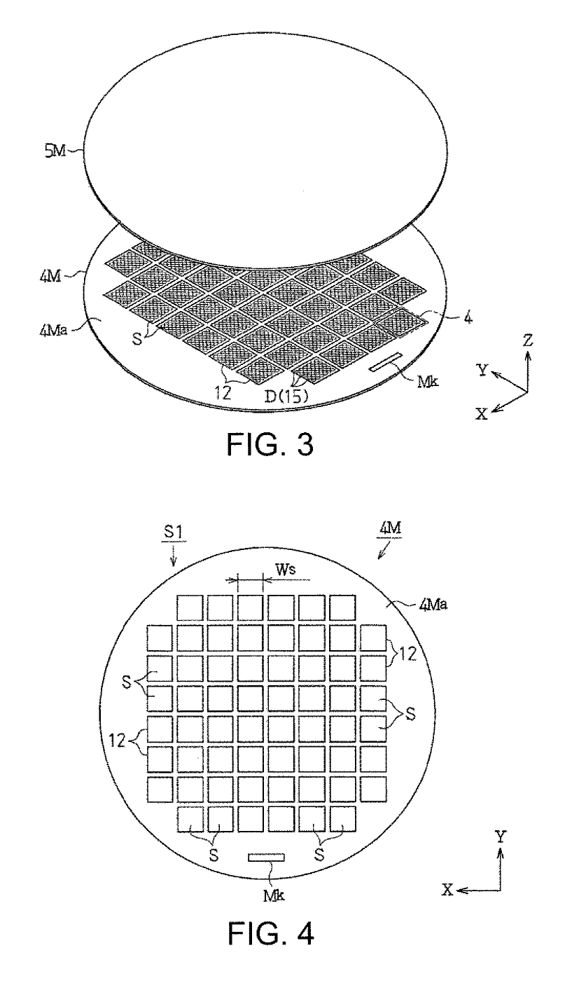

The above-described liquid crystal panel 2 is manufactured by the following manufacturing method. FIG. 3 is an explanatory diagram for explaining a method of manufacturing the liquid crystal panels 2.

In order to manufacture the liquid crystal panels 2, as shown in FIG. 3, on one surface (discharge-target surface 4Ma) of an eight-inch mother substrate (hereinafter, referred to simply as a discharge-target substrate 4M) from which the counter substrates 4 can be obtained by dicing, a plurality of sealing members 12 that have a rectangular frame shape corresponding to the counter substrate 4 are formed by coating. Thus, as shown in FIG. 4, regions (discharge-target regions S) that are surrounded by the sealing members 12 arranged in a matrix are formed on the discharge-target surface 4Ma of the discharge-target substrate 4M. On the discharge-target surface 4Ma corresponding to each discharge-target region S, the counter electrode 6 and the alignment layer 7a are formed. In addition, at the end of the discharge-target substrate 4M existing in the negative Y-axis direction from the center of the substrate 4M, a marking Mk in which a manufacturing number and so forth of the substrate 4M are marked is formed.

In the present embodiment, the discharge-target regions S formed on the discharge-target substrate 4M are referred to as first-row discharge-target regions S, second-row discharge-target regions S, . . . , and eighth-row discharge-target regions S in that order from the positive side of the Y-axis (from the end of the discharge-target substrate 4M on the opposite side of the marking Mk). In addition, the discharge-target regions S are referred to as first-column discharge-target regions S, second-column discharge-target regions S, . . . , and eighth-column discharge-target regions S in that order from the positive side of the X-axis. Furthermore, the first-column discharge-target regions and the second-column discharge-target regions are defined as first discharge-target regions S1. The width of each of the discharge-target regions S along the X-axis direction is referred to as a discharge width Ws.

After the discharge-target regions S have been formed on the discharge-target substrate 4M, droplets D of the liquid crystal 15 with a predetermined volume are discharged in each of the discharge-target regions S as shown in FIG. 3. Subsequently, applied to the discharge-target surface 4Ma of the discharge-target substrate 4M is another eight-inch mother substrate (hereinafter, referred to simply as an applying substrate 5M) from which the element substrates 5 can be obtained by dicing. The sealing members 12 are then cured. On the surface of the applying substrate 5M facing the discharge-target surface 4Ma, the scan lines 8, the data lines 9, the pixel regions 10, the pixel electrodes 11, and so on corresponding to the respective discharge-target regions S have been formed.

Subsequently, after dicing of the discharge-target substrate 4M and the applying substrate 5M that have been applied to each other due to the curing of the sealing members 12, liquid crystal layers 15L sealed by the sealing members 12 are formed in the gaps between the element substrates 5 and the counter substrates 4. Thus, the liquid crystal panels 2 are completed. The invention is not limited to the above-described configuration, in which the sealing members 12 (discharge-target regions S) are formed on the discharge-target substrate 4M and the droplets D of the liquid crystal 15 are discharged on the discharge-target substrate 4M. Another configuration is also applicable in which the respective discharge-target regions S are formed on the applying substrate 5M and the droplets D of the liquid crystal 15 are discharged on the applying substrate 5M.

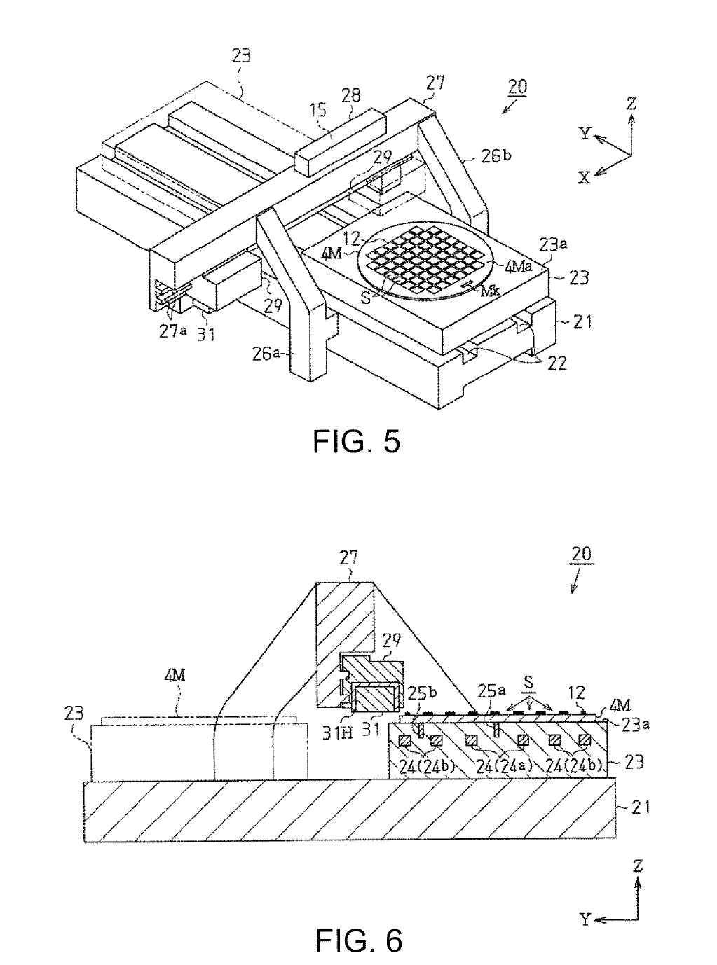

A droplet discharge device 20 for discharging the liquid crystal 15 on the discharge-target regions S on the discharge-target substrate 4M will be described below. FIG. 5 is a perspective view illustrating the droplet discharge device 20. FIG. 6 is a sectional view along the Y-axis of FIG. 5.

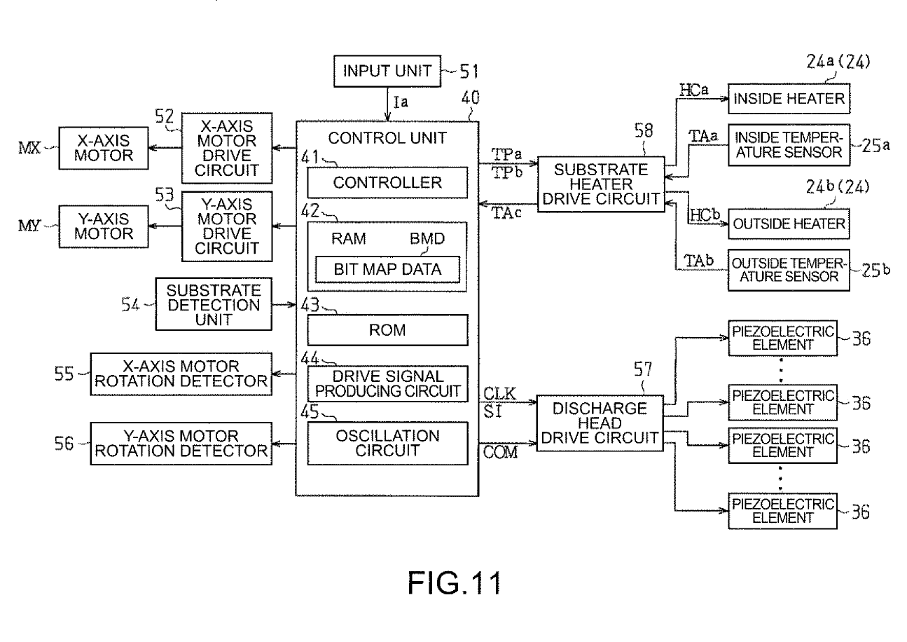

Referring to FIG. 5, the droplet discharge device 20 includes a base 21 formed into a rectangular shape. The base 21 is formed so that the discharge-target substrate 4M can be placed on a substrate stage 23 that will be described later and the longitudinal direction of the base 21 is parallel to the Y-axis direction. On the top face of the base 21, a pair of guide trenches 22 that extend in the Y-axis direction are formed across the entire length of the base 21 in the Y-axis direction, and attached to the guide trenches 22 is the substrate stage 23. The substrate stage 23 serves as a substrate temperature controller that is coupled to a Y-axis motor MY (see FIG. 11) and thus can move straight in the positive and negative Y-axis directions.

When a predetermined drive signal is input to the Y-axis motor MY, the Y-axis motor MY forward-rotates or reverse-rotates, so that the substrate stage 23 forward-moves or return-moves at certain speed in the Y-axis direction.

Formed on the top face of the substrate stage 23 is a placement face 23a that allows the discharge-target substrate 4M to be placed thereon with the discharge-target surface 4Ma (discharge-target regions S) being directed upward. Thus, the placed discharge-target substrate 4M is positioned to a predetermined placement position relative to the substrate stage 23. In the present embodiment, the discharge-target substrate 4M is positioned so that the first-row discharge-target regions S thereon are disposed closest to the end of the substrate stage 23 existing in the Y-axis direction from the center of the substrate stage 23.

As shown in FIG. 6, the substrate stage 23 includes substrate heaters 24 that form the substrate temperature controller for heating the discharge-target substrate 4M placed on the placement face 23a.

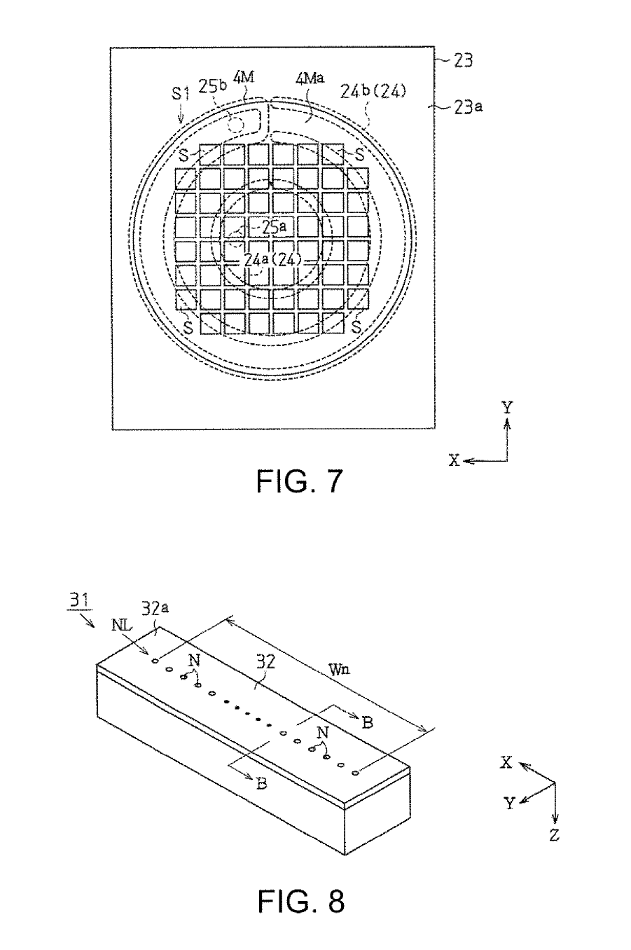

As shown in FIG. 7, the substrate heaters 24 includes an inside heater 24a and an outside heater 24b placed on the outer side of the inside heater 24a. The inside heater 24a is opposed to the vicinity of the center position of the discharge-target substrate 4M placed on the placement face 23a, and is formed into a substantially circle shape. The outside heater 24b is opposed to the vicinity of the outer periphery of the discharge-target substrate 4M, and is formed into a convolution shape. Between the inside heater 24a and the outside heater 24b, a heat insulating member (not shown) is provided.

The inside heater 24a receives an inside-heater drive signal HCa (see FIG. 11) for setting the temperature around the center position of the discharge-target substrate 4M to a predetermined temperature (inside target temperature), so as to heat the placement face 23a opposed to the vicinity of the center position of the discharge-target substrate 4M. In addition, the outside heater 24b receives an outside-heater drive signal HCb (see FIG. 11) for setting the temperature in the vicinity of the outer periphery of the discharge-target substrate 4M to a predetermined temperature (outside target temperature), so as to heat the placement face 23a opposed to the vicinity of the outer periphery of the discharge-target substrate 4M.

When the inside heater 24a and the outside heater 24b are supplied with the inside-heater drive signal HCa and the outside-heater drive signal HCb, respectively, the temperature around the center position of the discharge-target substrate 4M placed on the placement face 23a is increased to the inside target temperature due to a heat transfer from the inside heater 24a via the placement face 23a. In addition, the temperature in the vicinity of the outer periphery of the discharge-target substrate 4M is increased to the outside target temperature due to a heat transfer from the outside heater 24b via the placement face 23a.

That is, the substrate stage 23 of the present embodiment divides the discharge-target substrate 4M into the vicinity of the center position and the vicinity of the outer periphery. In addition, the substrate stage 23 increases the temperatures of the vicinity of the center position and the vicinity of the outer periphery to the inside target temperature and the outside target temperature, respectively, and maintains the increased temperatures at the target temperatures.

In this case, in the vicinity of the outer periphery of the discharge-target substrate 4M, the region exposed to an ambient air is larger compared with the vicinity of the center position. Since the vicinity of the outer periphery of the discharge-target substrate 4M has a larger region exposed to an ambient air, the heat exchange with the ambient air is fast and thus a heat is readily discharged in the vicinity of the outer periphery.

Therefore, if the amount of heat transferred from the outside heater 24b per unit area is smaller than or substantially equal to the amount of heat transferred from the inside heater 24a per unit area, the temperature of the vicinity of the outer periphery of the discharge-target substrate 4M becomes lower than that of the vicinity of the center position. If the temperature of the vicinity of the outer periphery of the discharge-target substrate 4M becomes lower than that of the vicinity of the center position, the amount of heat transferred to the region above the discharge-target regions S (the liquid crystal 15 in nozzles N that will be described later) in the vicinity of the outer periphery becomes smaller than that in the vicinity of the center position. In other words, the amount of heat transferred to the region above the discharge-target surface 4Ma varies depending on the position of the discharge-target region S.

Therefore, in the droplet discharge device 20 of the present embodiment, the amount of heat from the outside heater 24b per unit area is set larger than that from the inside heater 24a per unit area, to thereby suppress the variation in the amount of heat transferred to the region above the positions of the respective discharge-target regions S.

As shown in FIG. 6, an inside temperature sensor 25a and an outside temperature sensor 25b are provided at the positions that are included in the substrate stage 23 and face the vicinity of the center position and the vicinity of the outer periphery, respectively, of the discharge-target substrate 4M. The inside temperature sensor 25a and the outside temperature sensor 25b are temperature sensors that detect infrared rays and the like from the vicinity of the center position and the vicinity of the outer periphery, respectively, of the discharge-target substrate 4M. In addition, the inside temperature sensor 25a and the outside temperature sensor 25b output a signal corresponding to the detected temperature of the vicinity of the center position of the discharge-target substrate 4M (inside temperature detection signal TAa, see FIG. 11) and the detected temperature of the vicinity of the outer periphery thereof (outside temperature detection signal TAb, see FIG. 11), respectively.

As shown in FIG. 5, a pair of support columns 26a and 26b is provided upright on the both sides of the base 21 existing along the X-axis direction, and a guide member 27 that extends in the X-axis direction is stretched between the pair of support columns 26a and 26b. A container tank 28 is provided on the guide member 27, and includes the liquid crystal 15 as a liquid substance so that the liquid crystal 15 can be introduced into a droplet discharge head 31 that will be described later. In the present embodiment, the viscosity of the liquid crystal 15 is in the range of 50 cp to 100 cp. However, the viscosity is not limited thereto.

Below the guide member 27, a pair of guide rails 27a that extend in the X-axis direction is formed across substantially the entire length of the guide member 27 in the X-axis direction. Attached to the guide rails 27a is a carriage 29 as a moving unit that is coupled to an X-axis motor MX (see FIG. 11) so as to straight move in the positive and negative X-axis directions. When a predetermined drive signal is input to the X-axis motor MX, the X-axis motor forward-rotates or reverse-rotates, so that the carriage 29 forward-moves or return-moves in the X-axis direction.

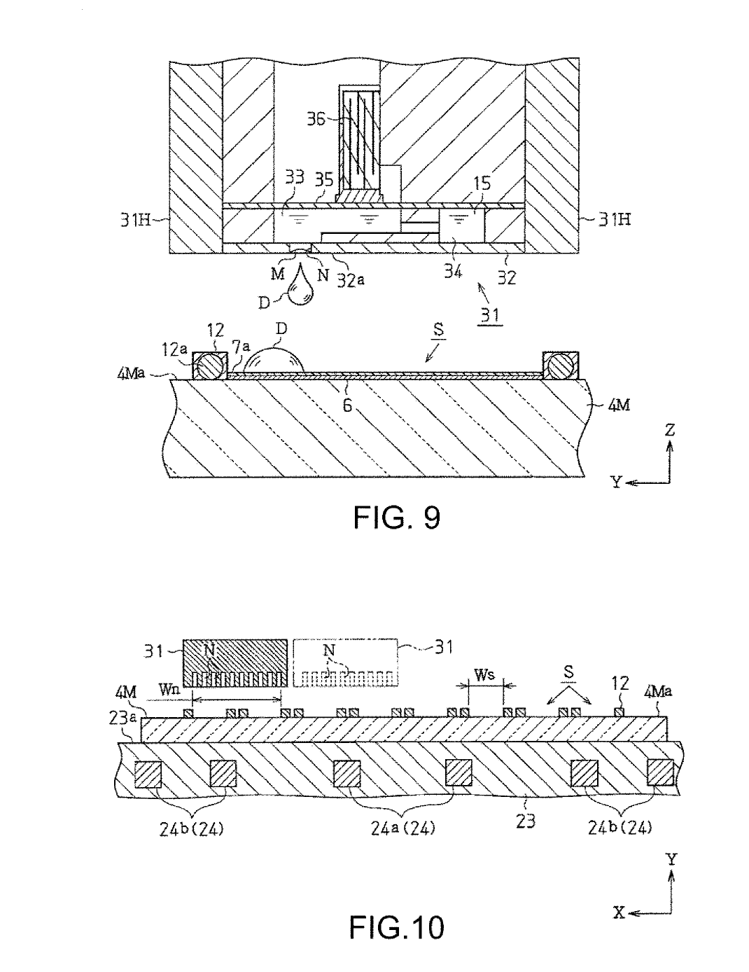

Provided below the carriage 29 is a droplet discharge head (hereinafter, referred to simply as a discharge head 31) as a droplet discharger. FIG. 8 is a perspective view of the discharge head 31 when being viewed from the underside (from the substrate stage 23). FIG. 9 is a sectional view along line B-B of FIG. 8.

Referring to FIG. 8, the discharge head 31 is formed into a substantially rectangular parallelepiped shape that extends in the X-axis direction. On the lower face thereof (facing the substrate stage 23), a nozzle plate 32 is provided. On the lower surface of the nozzle plate 32 (nozzle formed face 32a), discharge nozzles (hereinafter, referred to simply as the nozzles N) as a large number of discharge outlets that penetrate the nozzle plate 32 along the normal of the discharge-target substrate 4M (in the Z-axis direction) are arranged on one line along the X-axis direction so as to form one nozzle line NL. The width of the nozzle line NL in the X-axis direction (nozzle width Wn) is set to about twice the discharge width Ws of the discharge-target region S (see FIG. 4).

When the substrate stage 23 is moved along the Y-axis direction in the state in which the nozzle line NL is to face the first discharge-target regions S1, the nozzle line NL moves in the negative Y-axis direction relative to the first discharge-target regions S1 (the discharge-target regions S on the first and second columns), with covering the entire width of the first discharge-target regions S1 in the X-axis direction.

Subsequently, if the carriage 29 is moved in the negative X-axis direction, and then the substrate stage 23 is moved in the negative Y-axis direction in the state in which the nozzle line NL is to face the discharge-target regions S on the third and fourth columns, the nozzle NL moves in the Y-axis direction relative to the discharge-target regions S on the third and fourth columns (in the direction parallel to the columns of the discharge-target regions S), with covering the entire width of the discharge-target regions S on the third and fourth columns in the X-axis direction.

That is, due to the movement of the substrate stage 23 and the carriage 29, the nozzles N in the present embodiment move above and relative to the respective discharge-target regions S in the order of the discharge-target regions S on the first and second columns, the discharge-target regions S on the third and fourth columns, . . . , and the discharge-target regions S on the seventh and eights columns.

As shown in FIG. 9, for each of the nozzles N, a cavity 33 is formed along the Z-axis direction. The cavity 33 communicates with the container tank 28 via a supply channel 34 that is common to each of the nozzles N, so that the liquid crystal 15 is introduced from the container tank 28 into the cavity 33. The cavity 33 supplies the introduced liquid crystal 15 to the corresponding nozzle N. Provided on the cavity 33 is a diaphragm 35 that can vibrate in the positive and negative Z-axis directions, and thus can increase and decrease the volume of the cavity 33. Provided on the diaphragm 35 is piezoelectric elements 36 each corresponding to a respective one of the nozzles N. The piezoelectric element 36 receives a signal for driving and controlling the piezoelectric element 36 (piezoelectric element drive signal COM, see FIG. 11) so as to be contracted and expanded. This contraction and expansion causes the diaphragm 35 to vibrate in the positive and negative Z-axis directions so that the pressure in the cavity 33 is increased and decreased.

As shown in FIGS. 6 and 9, a head heater 31H as a liquid substance heater is provided around the discharge head 31. The head heater 31H heats the liquid crystal 15 in the cavity 33 so that the temperature of the liquid crystal 15 enters a certain temperature range (about 60 degrees centigrade in the present embodiment). The heating of the liquid crystal 15 in each of the cavities 33 by the head heater 31H decreases the viscosity of the liquid crystal 15 in the vicinity of the corresponding nozzle N, which allows the liquid crystal 15 to be discharged as the droplets D that will be described later. In the present embodiment, the head heater 31H is provided only around the discharge head 31. However, another heating heater may be separately provided also around a feed pipe and the like for the liquid crystal 15 from the container tank 28 to the discharge head 31.

When the first discharge-target regions S1 being carried in the Y-axis direction are positioned directly below the discharge head 31, the piezoelectric elements 36 of the corresponding nozzles 36 contract and expand. Thus, the pressures of the corresponding cavities 33 are increased and decreased, so that the boundaries (meniscuses M) of the liquid crystal 15 in the nozzles N vibrate in the positive and negative Z-axis directions. Since the viscosity of the liquid crystal 15 has been decreased due to the heating by the head heater 31H, the vibration of the meniscus of the liquid crystal 15 allows the liquid crystal 15 to be discharged as the droplets D smoothly. The discharged droplets D fly from the corresponding nozzles N in the negative Z-axis direction so as to land on the corresponding discharge-target region S of the first discharge-target regions S1.

At this time, when the discharge head 31 is opposed to the vicinity of the outer periphery of the discharge-target surface 4Ma (for example, the discharge-target regions S on the first row of the first discharge-target regions S1) as shown by the full line in FIG. 10, heat is transferred to the discharge head 31 (liquid crystal 15) only from the vicinity of the center position of the discharge-target surface 4Ma. In contrast, when the discharge head 31 is positioned above the vicinity of the center position of the discharge-target surface 4Ma (for example, the discharge-target regions S on the third and fourth columns and on the fourth row) as shown by the chain double-dashed line in FIG. 10, heat is transferred to the discharge head 31 (liquid crystal 15) from substantially the whole of the discharge-target surface 4Ma.

That is, of the liquid crystal 15 in the nozzles N facing the respective discharge-target regions S, the region to which heat is supplied from the discharge-target substrate 4M becomes larger as the position of the nozzles N approaches the vicinity of the center position of the discharge-target surface 4Ma. In contrast, the region to which heat is supplied from the discharge-target substrate 4M becomes smaller as the position of the nozzles N approaches the vicinity of the outer periphery of the discharge-target surface 4Ma.

Therefore, if the outside actual temperature of the discharge-target substrate 4M is lower than or substantially equal to the inside actual temperature thereof, the liquid crystal 15 in the nozzles N opposed to the vicinity of the outer periphery is supplied with positive heat of which amount is smaller than the amount of heat transferred to the liquid crystal 15 in the nozzles N opposed to the vicinity of the center position.

That is, the temperature of the liquid crystal 15 in the nozzles N varies depending on the position of the discharge head 31. Therefore, the viscosity of the liquid crystal 15 in the nozzles N varies depending on the position of the discharge-target regions S, which leads to variation in the volume of the discharged liquid crystal 15.

Consequently, in the droplet discharge device 20 of the present embodiment, the amount of heat from the outside heater 24b per unit area is set larger than the amount of heat transmitted from the inside heater 24a per unit area, and the outside target temperature is set higher than the inside target temperature. In other words, in the droplet discharge device 20 of the present embodiment, the outside actual temperature is set higher than the inside actual temperature in order to compensate the variation in the amount of heat transferred to the discharge head 31 depending on the region.

Thus, substantially the same amount of heat is uniformly transferred to the entire liquid crystal 15 in the respective nozzles N facing the discharge-target regions S since the outside actual temperature is set higher than the inside actual temperature. Accordingly, variation in the volume of the liquid crystal 15 discharged on the discharge-target regions S can be suppressed.

The inside target temperature and the outside target temperature in the present embodiment are set based on experimental tests and the like that have been carried out in advance, and are set to such temperatures that the amount of heat transferred from the discharge-target surface 4Ma to the discharge head 31 becomes substantially uniform across the entire region above all the discharge-target regions S and thus the volume of the liquid crystal 15 discharged on the respective discharge-target regions S becomes uniform. For example, the droplet discharge device 20 is placed under an atmosphere of which temperature is maintained at 20 degrees centigrade, and the inside and outside target temperatures are set to 30 and 35 degrees centigrade, respectively. However, the temperature condition is not limited thereto.

The electrical configuration of the droplet discharge device 20 having the above-described configuration will be described below with reference to FIG. 11.

Referring to FIG. 11, a control unit 40 includes a controller 41 as an energization drive control unit formed of a CPU or the like, a RAM 42 that is formed of DRAM and SRAM and stores various kinds of data, and a ROM 43 as a storage that stores various kinds of data and various kinds of control programs. In addition, the control unit 40 also includes a drive signal producing circuit 44 that produces the piezoelectric element drive signal COM, an oscillation circuit 45 that produces a clock signal CLK for synchronizing various kinds of signals, and other components. In the control unit 40, the controller 41, the RAM 42, the ROM 43, the drive signal producing circuit 44, and the oscillation circuit 45 are coupled to each other via a bus (not shown).

An input unit 51 is coupled to the control unit 40. The input unit 51 has operating switches such as an activation switch and a stop switch, and outputs operation signals arising from operations of the switches to the control unit 40. Furthermore, the input unit 51 outputs to the control unit 40, data including information on the discharge positions of the liquid crystal 15 to be discharged on the discharge-target surface 4Ma (the positions of the discharge-target regions S on the discharge-target surface 4Ma), the set temperatures of the discharge-target substrate 4M (inside and outside target temperatures), and other information as discharge data Ia with a certain format. In accordance with the discharge data Ia from the input unit 51 and a control program (for example, a liquid crystal discharge program) stored in the ROM 43 or the like, the control unit 40 moves the substrate stage 23 so as to implement operation of carrying processing for the discharge-target surface 4Ma, and drives the piezoelectric elements 36 of the discharge head 31 so as to implement operation of droplet discharge processing for the liquid crystal 15.

Specifically, the controller 41 executes predetermined development processing for the discharge data Ia from the input unit 51 so as to create bit map data BMD that indicates whether or not the droplet D is discharged for each position on a two dimensional drawing plane (discharge-target surface 4Ma), and store the created bit map data BMD in the RAM. In the bit map data BMD, turning on/off of the piezoelectric element 36 (whether or not the droplet D is discharged) is defined according to the bit value (0 or 1). Subsequently, the controller 41 synchronizes the bit map data BMD with the clock CLK generated by the oscillation circuit 45 so as to transfer data for each scanning (forward-movement and return-movement of the substrate stage 23) to a discharge head drive circuit 57 as a discharge control signal SI.

In addition, the controller 41 executes for the discharge data Ia from the input unit 51, development processing different from the development processing for the bit map data BMD, so as to produce waveform data of the piezoelectric element drive signal COM and outputs the data to the drive signal producing circuit 44. The drive signal producing circuit 44 stores the waveform data from the controller 41 in a waveform memory (not shown). The drive signal producing circuit 44 then performs digital/analog conversion for the stored waveform data and amplifies the resultant analog waveform signal so as to produce the piezoelectric element drive signal COM for driving the piezoelectric elements 36. Subsequently, the controller 41 outputs the piezoelectric element drive signal COM to the discharge head drive circuit 57 that will be described later.

Furthermore, the controller 41 performs predetermined development processing for the discharge data Ia from the input unit 51 so as to produce an inside-target-temperature signal TPa and an outside-target-temperature signal TPb for producing the inside-heater drive signal HCa and the outside-heater drive signal HCb corresponding to the inside target temperature and the outside target temperature, respectively. The controller 41 then outputs the inside-target-temperature signal TPa and the outside-target-temperature signal TPb to a substrate heater drive circuit 58 that will be described later.

As shown in FIG. 11, an X-axis motor drive circuit 52 is coupled to the control unit 40 so that an X-axis motor drive control signal is output to the X-axis motor drive circuit 52. In response to the X-axis motor drive control signal from the control unit 40, the X-axis motor drive circuit 52 forward-rotates or reverse-rotates the X-axis motor MX for reciprocating the carriage 29. When the X-axis motor MX is forward-rotated for example, the carriage 29 moves in the positive X-axis direction. In contrast, when the X-axis motor MX is reverse-rotated, the carriage 29 moves in the negative X-axis direction.

A Y-axis motor drive circuit 53 is coupled to the control unit 40 so that a Y-axis motor drive control signal is output to the Y-axis motor drive circuit 53. In response to the Y-axis motor drive control signal from the control unit 40, the Y-axis motor drive circuit 53 forward-rotates or reverse-rotates the Y-axis motor MY for reciprocating the substrate stage 23 (discharge-target substrate 4M). When the Y-axis motor MY is forward-rotated for example, the substrate stage 23 (discharge-target substrate 4M) moves in the positive Y-axis direction. In contrast, when the Y-axis motor MY is reverse-rotated, the substrate stage 23 (discharge-target substrate 4M) moves in the negative Y-axis direction.

A substrate detection unit 54 is coupled to the control unit 40. The substrate detection unit 54 detects an edge of the counter substrate 4 and thus is used when the control unit 40 calculates the position of the discharge-target substrate 4M (discharge-target region S) that passes directly below the carriage 29.

The control unit 40 is coupled to an X-axis motor rotation detector 55, and is fed with a detection signal from the X-axis motor rotation detector 55. The control unit 40 detects the rotation direction and rotation amount of the X-axis motor MX based on the detection signal from the X-axis motor rotation detector 55, so as to calculate the amount of the movement of the carriage 29 along the X-axis and the movement direction thereof.

The control unit 40 is coupled to a Y-axis motor rotation detector 56, and is fed with a detection signal from the Y-axis motor rotation detector 56. The control unit 40 detects the rotation direction and rotation amount of the Y-axis motor MY based on the detection signal from the Y-axis motor rotation detector 56, so as to calculate the amount of the movement of the substrate stage 23 (discharge-target region S) along the Y-axis and the movement direction thereof.

The control unit 40 is coupled to the discharge head drive circuit 57, and outputs the discharge control signal SI, the clock signal CLK and the piezoelectric element drive signal COM to the discharge head drive circuit 57. In response to the discharge control signal SI from the control unit 40, the discharge head drive circuit 57 controls whether or not the piezoelectric element drive signal COM is supplied to the corresponding piezoelectric elements 36.

The substrate heater drive circuit 58 is coupled to the control unit 40 so that the inside-target-temperature signal TPa and the outside-target-temperature signal TPb are output to the substrate heater drive circuit 58. Coupled to the substrate heater drive circuit 58 are the inside temperature sensor 25a and the outside temperature sensor 25b. Thus, the substrate heater drive circuit 58 is fed with the inside temperature detection signal TAa from the inside temperature sensor 25a and the outside temperature detection signal TAb from the outside temperature sensor 25b.

The substrate heater drive circuit 58 produces a signal (the inside-heater drive signal HCa) for setting the temperature of the vicinity of the center position of the discharge-target substrate 4M to the inside target temperature based on the inside-target-temperature signal TPa from the control unit 40 and the inside temperature detection signal TAa from the inside temperature sensor 25a, so as to output the inside-heater drive signal HCa to the inside heater 24a. The substrate heater drive circuit 58 produces a signal (the outside-heater drive signal HCb) for setting the temperature of the vicinity of the outer periphery of the discharge-target substrate 4M to the outside target temperature based on the outside-target-temperature signal TPb from the control unit 40 and the outside temperature detection signal TAb from the outside temperature sensor 25b, so as to output the outside-heater drive signal HCB to the outside heater 24b. When the inside actual temperature and the outside actual temperature of the discharge-target substrate 4M have attained the inside target temperature and the outside target temperature, respectively, the substrate heater drive circuit 58 produces a target temperature attainment signal TAc indicating that the temperatures of the discharge-target substrate 4M have attained the target temperatures, so as to output the target temperature attainment signal TAc to the control unit 40.

A droplet discharge method in which the liquid crystal 15 is discharged on the discharge-target substrate 4M by use of the droplet discharge device 20 will be described below.

Initially, as shown in FIG. 5, the discharge-target substrate 4M is placed and fixed onto the substrate stage 23 with the discharge-target surface 4Ma being directed upward. In this state, the discharge data Ia is input to the input unit 51, and an operation signal for initializing a liquid crystal discharge program is input.

Based on the discharge data Ia, the control unit 40 produces the inside-target-temperature signal TPa and the outside-target-temperature signal TPb. Subsequently, the control unit 40 causes the substrate heater drive circuit 58 to produce the inside-heater drive signal HCa and the outside-heater drive signal HCb based on the inside-target-temperature signal TPa and the outside-target-temperature signal TPb, respectively, and output the inside-heater drive signal HCa and the outside-heater drive signal HCb to the inside and outside heaters 24a and 24b, respectively. Thus, the control unit 40 drives the inside and outside heaters 24a and 24b so that the inside and outside actual temperatures of the discharge-target substrate 4M placed on the placement face 23a are increased to and maintained at the inside and outside target temperatures, respectively.

When the inside and outside actual temperatures have been increased to and are maintained at the inside and outside target temperatures, respectively, the control unit 40 receives the target temperature attainment signal TAc from the substrate heater drive circuit 58, and drives and controls the X-axis motor MX so as to move the carriage 29. Thus, the control unit 40 sets the carriage 29 to such a position that the first discharge-target regions S1 (the discharge-target regions S on the first and second columns) pass directly below the discharge head 31 (nozzle line NL) when the discharge-target substrate 4M moves in the Y-axis direction. In addition, the control unit 40 drives and controls the Y-axis motor MY so as to carry the substrate stage 23 (discharge-target substrate 4M) in the Y-axis direction. Specifically, the control unit 40 carries the respective discharge-target regions S of the first discharge-target regions S1 toward the discharge head 31 in the order from the first row.

When the substrate detection unit 54 detects the edge of the discharge-target substrate 4M (discharge-target surface 4Ma) existing in the positive Y-axis direction from the center of the substrate 4M, the control unit 40 calculates whether or not the ends of the discharge-target regions S on the first row of the first discharge-target regions S1 existing in the positive Y-axis direction from the center of the substrate 4M have been carried to the position directly below the nozzle low NL based on a detection signal from the Y-axis motor rotation detector 56. The control unit 40 waits for the timing at which the discharge control signal SI corresponding to the first discharge-target regions S1 is output to the discharge head drive circuit 57.

When the ends of the discharge-target regions S on the first row of the first discharge-target regions S1 existing in the positive Y-axis direction from the center of the discharge-target substrate 4M have been carried to the position directly below the nozzle low NL, the control unit 40 outputs the discharge control signal SI to the discharge head drive circuit 57 in response to the detection signal from the Y-axis motor rotation detector 56. The discharge head drive circuit 57 receives the discharge control signal SI from the control unit 40, and supplies the piezoelectric element drive signal COM to the corresponding piezoelectric elements 36. The discharge head drive circuit 57 then causes the discharge head 31 to discharge the droplets D on the discharge-target regions S in the order from the first row to the eighth row sequentially, based on the discharge control signal SI.

At this time, the discharge-target regions S in the vicinity of the outer periphery of the discharge-target substrate 4M (for example, the discharge-target regions S on the first column) receive heat from the outside heater 24b so that the temperature thereof is maintained at the outside target temperature. In addition, the discharge-target regions S in the vicinity of the center position (for example, the discharge-target regions S on the second column and on the fourth to sixth rows) receive heat from the inside heater 24a so that the temperature thereof is maintained at the inside target temperature.

Therefore, substantially the same amount of heat is transferred from the discharge-target surface 4Ma to the discharge head 31 (the liquid crystal 15 in the nozzles N) across all of the discharge-target regions S of the first discharge-target regions S1. Thus, the discharge head 31 discharges the liquid crystal 15 with a uniform volume corresponding to the piezoelectric element drive signal COM on the discharge-target regions S of the first discharge-target regions S1.

Subsequently, every time the discharge-target regions S on the third to eighth columns are sequentially carried to the position directly below the nozzle line NL, the control unit 40 discharges the liquid crystal 15 with a uniform volume corresponding to the piezoelectric element drive signal COM similarly. After the liquid crystal 15 with a uniform volume has been discharged on all the discharge-target regions S, the control unit 40 moves the substrate stage 23 so that the discharge-target substrate 4M is moved away from the position directly below the discharge head 31, and then terminates the liquid crystal discharge program.

Thus, the liquid crystal 15 having the same volume can be discharged on all the discharge-target regions S on the discharge-target substrate 4M, and therefore the liquid crystal panel 2 in which the length of the gap (cell gap) between the counter substrate 4 and the element substrate 5 is uniform can be manufactured.

Advantageous effects of the first embodiment having the above-described configuration will be described below.

(1) According to the first embodiment, the inside heater 24a and the outside heater 24b positioned outside the inside heater 24a are provided. The inside heater 24a is opposed to the vicinity of the center position of the discharge-target substrate 4M and heats the vicinity of the center position. The outside heater 24b is opposed to the vicinity of the outer periphery of the discharge-target substrate 4M and heats the vicinity of the outer periphery. In addition, the inside-heater drive signal HCa and the outside-heater drive signal HCb are supplied to the inside heater 24a and the outside heater 24b, respectively, so that the amount of the heat provided from the outside heater 24b to the discharge-target substrate 4M per unit area is set larger than that provided from the inside heater 24a to the discharge-target substrate 4M per unit area.

As a result, a decrease of the outside actual temperature relative to the inside actual temperature can be suppressed, which can enhance the uniformity of the amount of heat transferred from the discharge-target surface 4Ma to the discharge head 31. Accordingly, the uniformity of the volume of the liquid crystal 15 discharged on the respective discharge-target regions S can be enhanced.

(2) According to the above-described embodiment, the inside actual temperature of the discharge-target substrate 4M is increased to the inside target temperature due to a heat transfer from the inside heater 24a, and the outside actual temperature of the discharge-target substrate 4M is increased to the outside target temperature due to a heat transfer from the outside heater 24b. In addition, the outside target temperature is set higher than the inside target temperature, so that the outside actual temperature becomes higher than the inside actual temperature.

As a result, the difference between the inside and outside actual temperatures can compensate the variation in the amount of heat transferred to the discharge head 31 depending on the region. Thus, the uniformity of the volume of the liquid crystal 15 discharged on the respective discharge-target regions S can be further enhanced.

(3) According to the above-described embodiment, the inside heater 24a and the outside heater 24b are provided inside the substrate stage 23, so that the inside heater 24a and the outside heater 24b heat the discharge-target substrate 4M with the intermediary of the placement face 23a for positioning the discharge-target substrate 4M therebetween. As a result, the temperatures of the discharge-target substrate 4M can be increased to and maintained at the inside and outside target temperatures, respectively, irrespective of carrying of the discharge-target substrate 4M. Accordingly, the uniformity of the volume of the liquid crystal 15 discharged on the respective discharge-target regions S can be enhanced without deteriorating the performance of discharge processing for the liquid crystal 15.

### Second Embodiment

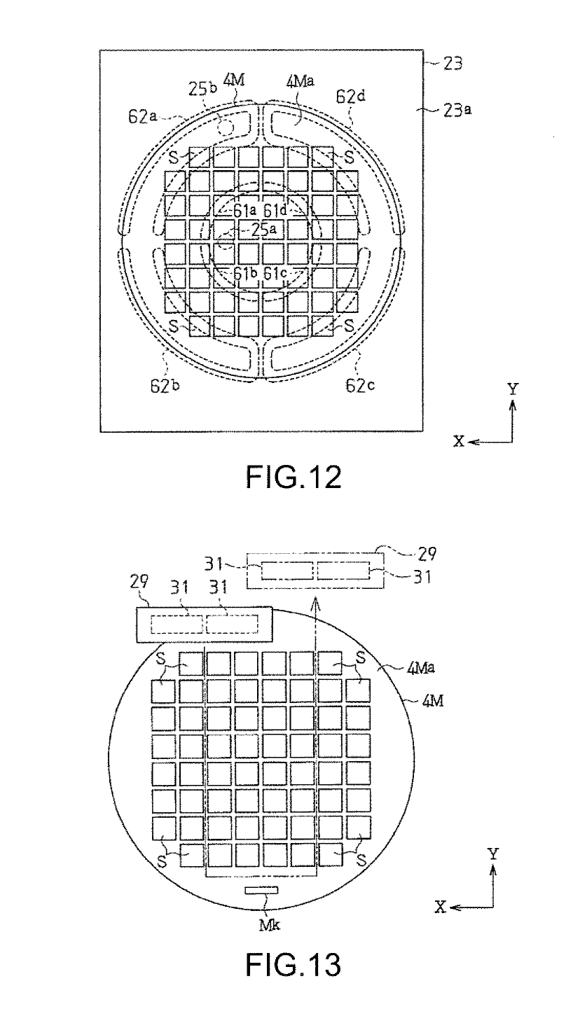

A second embodiment of the invention will be described below with reference to FIGS. 12 to 13. The second embodiment has a configuration obtained by modifying the substrate heaters 24 and the path of the movement of the discharge head 31 relative to the discharge-target substrate 4M in the first embodiment. Therefore, in the following description, modified points regarding the heaters 24 and the relative movement path of the discharge head 31 will be explained in detail. FIG. 12 is a plan view of the substrate stage 23 when being viewed from the upside. FIG. 13 is an explanatory diagram for explaining the relative movement path of the discharge head 31.

As shown in FIG. 12, provided in the substrate stage 23 are a first inside heater 61a, a second inside heater 61b, a third inside heater 61c, and a fourth inside heater 61d that each have a substantially arc shape and serve as a substrate temperature controller. The first to fourth inside heaters are placed on quarter circumferences resulting from quadrisection of the entire circumference on which the inside heater 24a of the first embodiment is placed. In addition, provided in the substrate stage 23 are a first outside heater 62a, a second outside heater 62b, a third outside heater 62c, and a fourth outside heater 62d that each have a substantially U-character shape and serve as the substrate temperature controller. The first to fourth outside heaters are placed on quarter circumferences resulting from quadrisection of the entire circumferences on which the outside heater 24b of the first embodiment is placed. Among the inside heaters 61a to 61d and the outside heaters 62a to 62d, a heat insulating member (not shown) is provided.

Each of the inside heaters 61a to 61d and each of the outside heaters 62a to 62d receive corresponding inside and outside heater drive signals, respectively, so as to heat the opposed region of the discharge-target substrate 4M. That is, the substrate stage 23 of the present embodiment increases and maintains the temperature of the discharge-target substrate 4M by use of the inside heaters 61a to 61d and the outside heaters 62a to 62d, with dividing the region of the discharge-target substrate 4M into eight regions that each face a respective one of the inside heaters 61a to 61d and the outside heaters 62a to 62d.

As shown in FIG. 13, the carriage 29 includes one pair of discharge heads 31 of the first embodiment arranged along the X-axis direction so that the nozzle lines NL (see FIG. 8) of the respective discharge heads 31 can face the neighboring discharge-target regions S on two columns. Due to the movement of the substrate stage 23 and the carriage 29, the discharge heads 31 of the present embodiment move relative to the discharge-target surface 4Ma along a substantially U-character relative movement path shown by the chain double-dashed line in FIG. 13.

Specifically, the droplet discharge device 20 of the present embodiment initially moves the carriage 29 so as to place the carriage 29 on such a position (shown by the full line in FIG. 13) that the nozzle lines NL are to face the discharge-target regions S on the first to fourth columns when the discharge-target substrate 4M is moved in the Y-axis direction. Then, the droplet discharge device 20 moves the substrate stage 23 in the Y-axis direction, and thus the nozzle lines NL move relative to the discharge-target substrate 4M in the negative Y-axis direction (the direction parallel to columns of the discharge-target regions S), with covering the entire width of the discharge-target regions S on the first to fourth columns in the X-axis direction.

Subsequently, the droplet discharge device 20 moves the carriage 29 in the negative X-axis direction so as to place the carriage 29 on such a position that the nozzle lines NL are to face the discharge-target regions S on the fifth to eighth columns when the discharge-target substrate 4M is moved in the negative Y-axis direction. Then, the droplet discharge device 20 moves the substrate stage 23 in the negative Y-axis direction, and thus the nozzle lines NL move relative to the discharge-target substrate 4M in the Y-axis direction (the direction parallel to columns of the discharge-target regions S), with covering the entire width of the discharge-target regions S on the fifth to eighth columns in the X-axis direction.

That is, the nozzle lines NL (discharge heads 31) move relative to the inside heaters 61a to 61d in the order of the first inside heater 61a, the second inside heater 61b, the third inside heater 61c, and the fourth inside heater 61d. In addition, the nozzle lines NL (discharge heads 31) move relative to the outside heaters 62a to 62d in the order of the first outside heater 62a, the second outside heater 62b, the third outside heater 62c, and the fourth outside heater 62d.

At this time, the discharge-target substrate 4M receives heat from the discharge heads 31 and the head heater 31H when the discharge heads 31 facing the discharge-target substrate 4M move relative to the discharge-target substrate 4M. Since the speed of the heat transfer is high, the temperature of the discharge-target substrate 4M receiving heat from the discharge heads 31 gradually increases without being corrected by the inside heaters 61a to 61d and the outside heaters 62a to 62d. This gradual increase of the temperature of the discharge-target substrate 4M leads to a gradual increase of the amount of heat transferred to the liquid crystal 15 in the nozzles N, which gradually decreases the viscosity of the liquid crystal 15 in the nozzles N. That is, as the period of the relative movement of the discharge heads 31 to the respective discharge-target regions S increases, the volume of the discharged liquid crystal 15 increases.

Therefore, in the droplet discharge device 20 of the present embodiment, the amounts of heat from the inside heaters 61a to 61d and the outside heaters 62a to 62d are reduced stepwise along the relative movement direction of the discharge heads 31. Thus, the temperatures of the regions of the discharge-target substrate 4M corresponding to the inside heaters 61a to 61d and the outside heaters 62a to 62d are decreased stepwise along the relative movement direction of the discharge heads 31.

Specifically, the amounts of heat transferred from the inside heaters 61a to 61d to the discharge-target substrate 4M per unit area are sequentially reduced in the order of the first inside heater 61a, the second inside heater 61b, . . . , and the fourth inside heater 61d. Thus, the temperature of the discharge-target substrate 4M opposed to the first inside heater 61a is set highest, while the temperature of the discharge-target substrate 4M opposed to the fourth inside heater 61d is set lowest. That is, the inside heaters 61a to 61d provide a temperature gradient along the relative movement direction of the discharge heads 31 to the vicinity of the center position of the discharge-target substrate 4M.

Furthermore, the amounts of heat transferred from the outside heaters 62a to 62d to the discharge-target substrate 4M per unit area are sequentially reduced in the order of the first outside heater 62a, the second outside heater 62b, . . . , and the fourth outside heater 62d. Thus, the temperature of the discharge-target substrate 4M opposed to the first outside heater 62a is set highest, while the temperature of the discharge-target substrate 4M opposed to the fourth outside heater 62d is set lowest. That is, the outside heaters 62a to 62d provide a temperature gradient along the relative movement direction of the discharge heads 31 to the vicinity of the outer periphery of the discharge-target substrate 4M.

In the droplet discharge device 20 of the present embodiment, similarly to the first embodiment, the amount of heat per unit area from the respective outside heaters 62a to 62d is set larger than that from the respective inside heaters 61a to 61d, so that the temperature of the vicinity of the outer periphery of the discharge-target substrate 4M is set higher than that of the vicinity of the center position thereof.

During the relative movement of the discharge heads 31 along the relative movement path, the droplet discharge device 20 cancels increases in the temperatures of the discharge-target regions S by use of a temperature gradient that is provided by the inside heaters 61a to 61d in advance and a temperature gradient that is provided by the outside heaters 62a to 62d, so as to equalize the amount of heat transferred from the discharge-target regions S to the discharge heads 31.

Thus, substantially the same amount of heat is uniformly transferred to the entire liquid crystal 15 in the respective nozzles N facing the discharge-target regions S. Accordingly, the volume of the liquid crystal 15 discharged on the discharge-target regions S can be further equalized.

Advantageous effects of the second embodiment having the above-described configuration will be described below.

(1) According to the second embodiment, the substrate stage 23 is provided with the inside heaters 61a to 61d and the outside heaters 62a to 62d so that a temperature gradient along the relative movement direction of the discharge heads 31 is given to the discharge-target substrate 4M.

As a result, increases in the temperatures of the respective discharge-target regions S can be canceled due to the temperature gradient of the discharge-target substrate 4M along the relative movement direction, provided in advance. Therefore, irrespective of the relative movement path and the relative movement period of the discharge heads 31, the uniformity of the amount of heat transferred from the discharge-target surface 4Ma to the discharge heads 31 can be enhanced. Accordingly, the uniformity of the volume of the liquid crystal 15 discharged on the respective discharge-target regions S can be further enhanced.

The following modifications might be incorporated into the above-described embodiments.

In the above-described embodiments, the discharge-target substrate 4M is heated. However, the invention is not limited thereto but may have a configuration in which the discharge-target substrate 4M is cooled. In this case, the vicinity of the outer periphery of the discharge-target substrate 4M absorbs heat more readily than the vicinity of the center position. Therefore, it is preferable to supply negative heat to the discharge-target substrate 4M in such a manner that the absolute value of heat transferred to the vicinity of the outer periphery is larger than that of heat transferred to the vicinity of the center position.

In the above-described embodiments, the inside heater 24a (first to fourth inside heaters 61a to 61d) and the outside heater 24b (first to fourth outside heaters 62a to 62d) are provided inside the substrate stage 23. However, the invention is not limited thereto. Only the outside heater 24b (first to fourth outside heaters 62a to 62d) may be provided for the substrate stage 23, for example.

In the above-described embodiments, the substrate temperature controller is embodied as the substrate heaters 24 (the first to fourth inside heaters 61a to 61d and the first to fourth outside heaters 62a to 62d). However, the invention is not limited thereto. For example, the substrate temperature controller may be embodied as a light source that emits light such as infrared rays from the discharge-target surface 4Ma of the discharge-target substrate 4M, and the temperature of the discharge-target substrate 4M may be controlled based on the emission quantity of the light.

Alternatively, the substrate temperature controller may be embodied as a plurality of recesses formed in the placement face 23a so that the substrate 23 is heated or cooled so as to be adjusted to a certain temperature. Specifically, the temperature of the discharge-target substrate 4M may be controlled by use of differences in the contact area between the discharge-target substrate 4M and the placement face 23a.

That is, any measure is available as long as the amount of heat transferred to the vicinity of the outer periphery of the discharge-target substrate 4M and the amount of heat transferred to the vicinity of the center position thereof can be controlled.

In the above-described embodiments, the liquid substance heater is embodied as the head heater 31H. However, the invention is not limited thereto. For example, the liquid substance heater may be embodied as a heater that heats the liquid crystal 15 in the container tank 28, or alternatively may be embodied as a heater that heats the liquid crystal 15 in a pipe between the container tank 28 and the discharge head 31.

In the above-described embodiments, the droplet discharger is embodied as the discharge head 31. However, the invention is not limited thereto but the droplet discharger may be embodied as e.g. an air dispenser.

In the above-described embodiments, the liquid substance is embodied as the liquid crystal 15. However, the invention is not limited thereto but the liquid substance may be embodied as e.g. a metal ink containing metal fine particles. That is, any liquid substance is available as long as the viscosity of thereof is decreased due to heating and thus it can be discharged as droplets.

In the above-described embodiments, the liquid crystal display 1 is manufactured by discharging a liquid crystal as a liquid substance. However, the invention is not limited thereto. For example, it is also possible to, with embodying the liquid substance as a metal ink, manufacture various kinds of metal interconnects in the liquid crystal display 1 and metal interconnects in a display having a field effect device (FED, SED etc.) that includes planar electron emission elements and utilizes the luminescence of a fluorescent substance due to the electrons emitted from the elements.

What is claimed is:

1. A droplet discharge device comprising:
a droplet discharger that moves above and relative to a plurality of discharge-target regions formed on a substrate and discharges a droplet of a liquid substance on the discharge-target region;
a liquid substance heater that heats the liquid substance in the droplet discharger; and
a substrate temperature controller that sets the absolute value of an amount of heat transferred to a vicinity of an outer periphery of the substrate larger than the absolute value of an amount of heat transferred to a vicinity of a center position of the substrate.

2. The droplet discharge device according to claim 1, wherein the substrate temperature controller heats the substrate so as to set the temperature of the vicinity of the outer periphery of the substrate higher than the temperature of the vicinity of the center position of the substrate.

3. The droplet discharge device according to claim 1, wherein the substrate temperature controller provides the substrate with a temperature gradient along a relative movement direction of the droplet discharger in advance so that heat transferred from the droplet discharger to the substrate is cancelled at the discharge-target region facing the droplet discharger.

4. A droplet discharge device comprising:
a droplet discharger that moves above and relative to a plurality of discharge-target regions formed on a substrate and discharges a droplet of a liquid substance on the discharge-target region;
a liquid substance heater that heats the liquid substance in the droplet discharger; and
a substrate temperature controller that provides the substrate with a temperature gradient along a relative movement direction of the droplet discharger in advance so that heat transferred from the droplet discharger to the substrate is cancelled at the discharge-target region facing the droplet discharger.

5. The droplet discharge device according to claim 1, wherein the substrate temperature controller includes a heater for heating the substrate.

6. The droplet discharge device according to claim 1, wherein the substrate temperature controller includes a substrate stage on which the substrate is placed so that the substrate is allowed to move relative to the droplet discharger.

7. The droplet discharge device according to claim 1, wherein the liquid substance is a liquid crystal.

8. A method of manufacturing a liquid crystal display, comprising:
discharging a liquid crystal on either one of an element substrate and a counter substrate with use of the droplet discharge device according to claim 7; and
sealing the discharged liquid crystal in a gap between the element substrate and the counter substrate.

9. A liquid crystal display manufactured by the method of manufacturing a liquid crystal display according to claim 8.
